(19) United States
(12) Patent Application Publication
(10) Pub. No.: US 2010/0207302 A1
(43) Pub. Date: Aug. 19, 2010

(54) STAMPER MOLDING DIE AND METHOD FOR MOLDING STAMPER USING THE SAME

(75) Inventors: Yasuaki OOTERA, Yokohama-shi (JP); Shinobu SUGIMURA, Yokohama-shi (JP); Seiji MORITA, Yokohama-shi (JP); Masatoshi SAKURAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/709,206

(22) Filed: Feb. 19, 2010

(30) Foreign Application Priority Data
Feb. 19, 2009 (JP) 2009-036880

(51) Int. Cl. B29C 45/56

(52) U.S. Cl. 264/478; 425/546

(57) ABSTRACT

According to one embodiment, in a die for manufacturing a resin stamper, the following are defined the sizes of a resin injection hole and a cut punch receiving portion of a fixed-side template, areas in which a vacuum suction hole and an air-blow hole, respectively, are formed, the diameter of a cut punch on a moving-side template, and the taper angle of the peripheral portion of a cavity.

### CROSS-REFERENCE TO RELATED APPLICATIONS

This application is based upon and claims the benefit of priority from Japanese Patent Application No. 2009-036880, filed Feb. 19, 2009, the entire contents of which are incorporated herein by reference.

### BACKGROUND

1. Field

One embodiment of the present invention relates to a stamper used in a method for manufacturing a magnetic recording medium having discrete tracks on the surface of a magnetic recording layer.

2. Description of the Related Art

Discrete track recording media (DTR media) have been proposed in which recording tracks are physically separated from one another in order to improve the medium recording density of a hard disk drive (HDD) that is a magnetic recording apparatus.

In the discrete track recording medium, grooves are formed in the surface of the medium to provide separate tracks in order to increase the recording density in a track direction. In the medium, simultaneously with the formation of the grooves each between the tracks, servo patterns can be formed in the form of recesses and protrusions. Improved patterning eliminates the need to record servo signals in each recording medium, thus improving productivity.

For example, Jpn. Pat. Appln. KOKAI Publication No. 2003-157520 discloses that during the manufacture of the DTR medium, an imprint stamper is pressed against a resist applied to the surface of a magnetic recording layer to transfer a recess and protrusion pattern to the resist so that the resist can be used as a mask to process a magnetic recording layer.

As such conventional imprint stampers, Ni stampers produced or duplicated by an electroforming process are used as father stampers, mother stampers, or sun stampers. However, the electroforming process disadvantageously requires a long time such as about one hour for production of each Ni stamper. In contrast, the first, Ni stamper may be produced as a father stamper by the electroforming process, and a subsequently processed mother stamper or sun stamper may be produced using an injection molding process. Then, the resin imprint stamper can be obtained within a short production time such as about several seconds per stamper.

The injection molding process has been used to produce optical disks.

For example, in an optical disk such as a Digital Versatile Disc (DVD) in which two molding substrates are stuck together, a recess and protrusion pattern with a track pitch of at least 300 nm is formed on at least one molding substrate. The two molding substrates are stuck together via an adhesive with a thickness of several tens of μm. When a pit row or a land/groove structure with a track pitch of 300 nm is formed on the molding substrate in the optical disk by injection molding, burrs that may be formed at the boundary between the stamper and a die holding the stamper are prevented from severely affecting a sticking step by setting the height of the burrs to be less than or equal to the thickness of the adhesive layer. This is because the adhesive layer is thick enough to bury the burrs in the adhesive layer.

However, the pattern formed on the DTR medium has a track pitch and a recess and protrusion height both of at least 100 nm. Furthermore, the thickness of the resist applied onto a magnetic layer deposited on the medium substrate can be reduced to at most 100 nm. However, when the imprint stamper is pressed against the resist on the medium substrate, if a protrusion such as a burr or a step is present on the surface of the imprint stamper, a void may be created between the imprint stamper and the resist. This may disadvantageously prevent the recess and protrusion pattern on the imprint stamper from being transferred to the resist.

Additionally, with the increased density of the recess and protrusion pattern provided on the disc, an injection molding resin material has been selected which is subject to only insignificant molding contraction. Discs that are only insignificantly contracted are disadvantageously difficult to stably remove from the die after molding.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, 1D, 1E and 1F are sectional views showing process for forming a magnetic recording medium;

FIGS. 2A, 2B, 2C, 2D, 2E and 2F are sectional views showing process for manufacturing a metal stamper;

FIG. 3 is a schematic diagram showing the configuration of a resin stamper molding die according to the present invention;

FIG. 4 is a schematic diagram showing positions where molding burrs on the resin stamper is measured;

FIG. 5 is a schematic diagram showing an example of a work robot for use in a method according to the present invention;

FIG. 6 is a diagram showing results of measurement of the thickness of a resist and transfer unevenness in the magnetic recording medium according to the present invention based on polarized light observation; and

FIG. 7 is a diagram showing results of measurement of the thickness of a resist and transfer unevenness in the magnetic recording medium according to the present invention based on polarized light observation.

### DETAILED DESCRIPTION

Various embodiments according to the invention will be described hereinafter with reference to the accompanying drawings. In general, according to one embodiment of the invention, a resin stamper molding die having a combination of a fixed-side template and a moving-side template located opposite the fixed plate.

In the resin stamper molding die, a metal stamper with a recess and protrusion-shaped surface is placed on the fixed-side template. The surface of the recess and protrusion shape faces the moving-side template. The fixed-side template includes a cut punch receiving portion, an injection hole communicating with the cut punch receiving portion and through which an injection molding resin material is injected, a vacuum suction hole through which a metal stamper is suctioned, and an air-blow hole through which air is blown against an injection-molded resin stamper. The moving-side template includes a cut punch in the center and a taper on the peripheral portion of a cavity in the moving-side template.

The vacuum suction hole is formed in an area in which the metal stamper is placed and within the range of 4.0 to 6.0 mm from the center of the cut punch receiving portion. The air-blow hole is formed within the range of 2.0 to 4.7 mm from the center of the cut punch receiving portion. The metal stamper has a center hole with a diameter of 6.8 to 10.8 mm and has a disc diameter of at least 69.0 mm. The taper of the moving-side template is inclined at an angle of 5 to 10° to the center axis of the cut punch or the cut punch receiving portion.

The present invention provides a method for molding a disc-like resin stamper having a center hole and applied to transfer a recess and protrusion pattern making up discrete tracks to an ultraviolet-curable resin used as a mask through which the discrete tracks are formed in a surface of a magnetic recording layer.

In the method, the resin stamper is injection-molded using the above-described die.

The method includes:

performing vacuuming through the vacuum suction hole to allow a surface of the metal stamper located opposite the recess and protrusion shape to stick to the fixed-side template;

injecting an injection molding resin material through the injection hole and then pressurizing and cooling the material to obtain a molded component of the resin stamper;

using the cut punch to punch the molded component of the resin stamper to form the resin stamper;

blowing air against the molded component through the air-blow hole attached to the fixed-side template to separate and remove the resin stamper from the fixed-side template;

removing, from the fixed-side template, the moving-side template and the resin stamper accommodated in the moving-side template;

suctioning a portion of the resin stamper outside the range of 65 mm from the center of resin stamper to remove the resin stamper from the fixed-side template.

The cut punch receiving portion may have a diameter of, for example, 2.6 to 4.0 mm.

The moving-side template may further have an air-blow hole through which air is blown against the injection-molded resin stamper.

According to the present invention, burrs on the resin stamper, which may affect the sticking of a DRT medium to the resin stamper via a thin ultraviolet-curable resin stamper of thickness several tens of nanometers, are arranged at positions where the burrs are prevented from affecting the characteristics of the magnetic recording medium, which is a final product.

According to the present invention, even when a molding material that is subject to only insignificant molding contraction is used in association of the increased density of a pattern, the molded component can be easily and stably removed from the die.

According to the present invention, the punching, by the cut punch, of the center hole, which is the greatest source of dust during the injection molding of the resin stamper, is designed to lie away from a magnetic recording medium. This enables to prevent the magnetic recording medium from being contaminated with cut punch chips.

The resin stamper according to the present invention can be used to manufacture a magnetic recording medium with discrete tracks.

The present invention will be described below in detail with reference to the drawings.

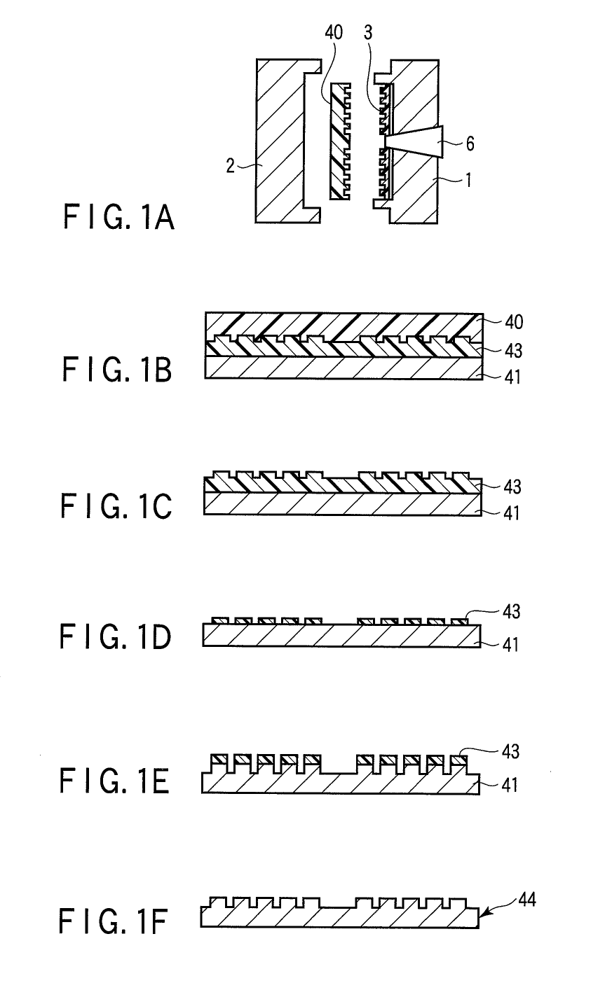

FIG. 1 is a sectional view showing process for forming a magnetic recording medium with discrete tracks using a resin stamper.

To form a magnetic recording medium using a resin stamper, first, the process shown in FIG. 1A is carried out. That is, a die having a fixed-side template 1 and a moving-side template 2 is prepared. Metal with a recess and protrusion pattern corresponding to discrete tracks, for example, an Ni stamper 3, is then placed on the fixed-side template 1 so that the recess and protrusion pattern faces the moving-side template 2. The fixed-side template 1 and the moving-side template 2 are laid on top of each other. A molten injection molding resin is injected into a cavity between the fixed-side template 1 and the moving-side template 2 through an injection hole 6 leading to the central portion of the fixed-side template 1. The injection molding resin is then pressurized and cooled to injection-mold a resin stamper 40. Recesses and protrusions for tracks and servo patterns are carved in the surface of the metal stamper 3. Thus, the recesses and protrusions for the tracks and servo patterns are transferred to a resin molded component (resin stamper) obtained using the metal stamper 3 as a die. For example, cycloolefin polymer or polycarbonate, or acrylic may be used as an injection molding resin material.

Then, as shown in FIG. 1B, an ultraviolet-curable resin 43 is applied to the surface of a magnetic recording medium 41. The resin stamper 40 is then pressed against the ultraviolet-curable resin 43 and irradiated with ultraviolet rays for curing (UV imprinting).

Subsequently, as shown in FIG. 1C, the resin stamper 40 is stripped from the ultraviolet-curable resin. The resin stamper is stripped to expose an ultraviolet-curable resin layer to which the recesses and protrusions for the tracks and servo patterns have been transferred.

Thereafter, as shown in FIG. 1D, residues of the ultraviolet-curable resin 43 inside the recesses of the pattern are removed by dry etching with, for example, CF₄ gas or O₂ gas. The ultraviolet-curable resin 42 is thus bottomed out until the surface of the magnetic recording medium 41 is exposed in the recesses of the recess and protrusion pattern.

As shown in FIG. 1E, the surface of the magnetic recording medium 41 is processed by ion milling with, for example, Ar through the ultraviolet-curable resin 43 as a mask. Thus, the recesses and protrusions for the tracks and servo patterns are formed on the surface of the magnetic recording medium 41. The surface of the magnetic recording medium 41 is processed by ion milling.

Thereafter, as shown in FIG. 1F, the ultraviolet-curable resin 43 is removed by dry etching to obtain a discrete track type magnetic recording medium 44.

A postprocess can be carried out on the magnetic recording medium obtained as required. For example, a nonmagnetic substance may be buried in the recesses of the pattern, a lubricant may be applied to the magnetic recording medium, or the magnetic recording medium may be polished with a tape.

The magnetic recording medium used herein is 1.8 inches in size, and has, for example, a diameter of 48±0.2 mm, a center hole diameter of 12.01±0.01 mm, and a thickness of 0.508±0.05 mm. However, a 2.5-inch medium (a diameter of 65±0.2 mm, a center hole diameter of 20.01±0.01 mm, and a thickness of 0.635±0.05 mm) may also be used.

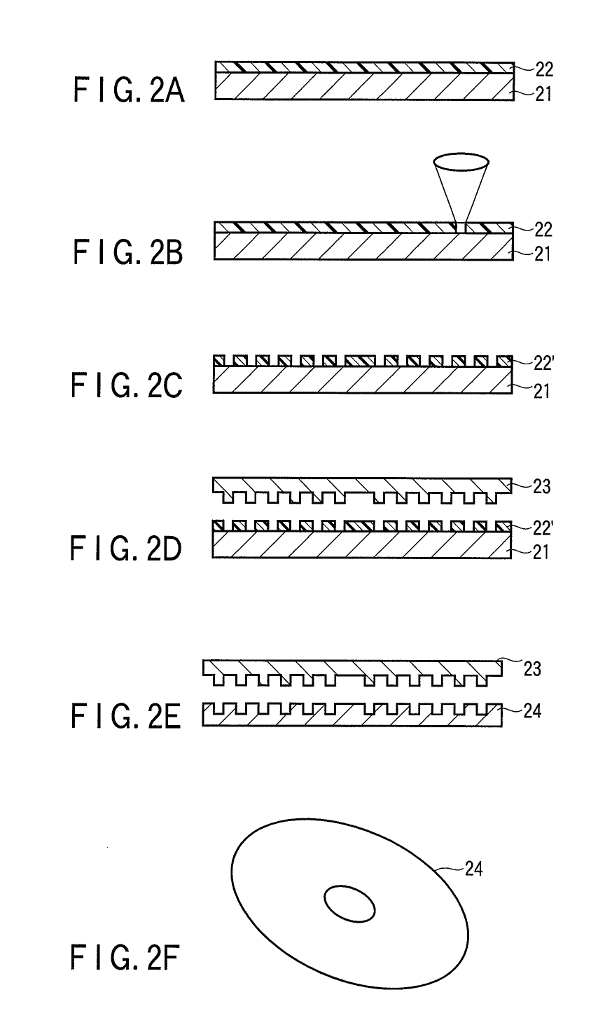

FIG. 2 is a diagram showing process for manufacturing a metal stamper.

As shown in FIG. 2A, first, an electron beam resist is applied onto an Si wafer.

Then, as shown in FIG. 2B, an electron beam resist is exposed to electron beams to form tracks and servo patterns on the electron beam resist.

Subsequently, as shown in FIG. 2C, the electron beam resist is developed to melt exposed or unexposed portions to form recesses and protrusions 22′ for the tracks and servo patterns.

As shown in FIG. 2D, the recesses and protrusions 22′ on the electron beam resist are made conductive and then plated with nickel. The pattern is thus duplicated with Ni to produce an Ni father stamper 23.

Thereafter, the Ni father stamp 23 is plated with Ni to produce an Ni mother stamper 24.

A sun stamper and a daughter stamper may be produced as required.

As shown in FIG. 2F, the back surface of the Ni mother stamper 24 is polished to process a center hole and an outer periphery. The Ni mother stamper 24 is thus shaped like a donut so as to be attached to an injection molding die.

In the process of manufacturing a discrete track type magnetic recording medium, the injection molding in FIG. 1A, and sticking with the ultraviolet-curable resin in FIG. 1B are the application of process steps for optical discs. However, these steps are significantly different from the corresponding ones for optical discs in that the ultraviolet-curable resin layer to be stuck is very thin, 20 to 90 nm. This thickness is selected because the value corresponds to a thickness sufficient to use the ultraviolet-curable resin layer as a mask during ion milling processing, to a height (aspect) at which a pattern can sufficiently be formed during the electron beam exposure in FIG. 2B, and to a thickness at which no burden is imposed on the exposure of bottom by dry etching in FIG. 1C.

Here, a problem is that not only the desired recess and protrusion pattern but also unavoidable recesses and protrusions, particularly protrusions are present on the injection-molded resin stamper. The protrusions are, for example, a clamp portion for a mechanical clamp normally used to attach a stamper to a die, an air-blow hole for mold-releasing air-blow carried out to remove the molded component from the injection molding die, and the like. These are steps or holes which are present on a stamper side of the injection molding die and which are transferred to the surface of the molded component as protrusions.

Thus, the present invention uses a vacuum suction scheme to attach the stamper to the die. This enables the need for the step such as the mechanical clamp to be eliminated.

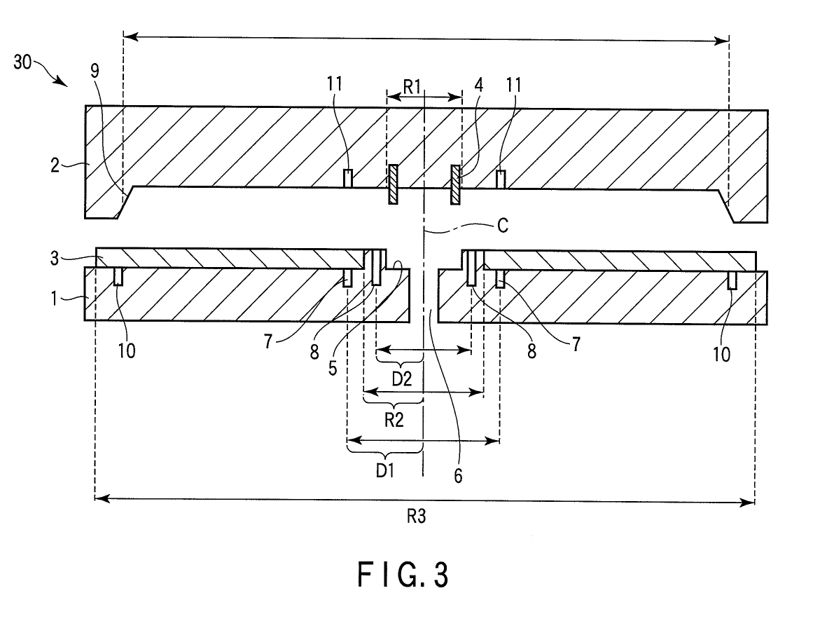

FIG. 3 is a schematic diagram showing the configuration of the resin stamper molding die according to the present invention.

As shown in FIG. 3, the die 30 has a combination of the fixed-side template 1, the metal stamper 3 placed on the fixed-side template 1 and having a recess and protrusion-shaped surface (not shown in the drawings), and the moving-side template 2 located opposite the fixed-side template 1 via the metal stamper 3.

The fixed-side template 1 has a cut punch receiving portion 5 receiving a cut punch 4 that punches a center hole with a diameter Ri in the resin stamper, and an injection hole 6 communicating with the cut punch receiving hole 5 and through which an injection molding resin material. The fixed-side template 1 also has a vacuum suction hole 7 in an area in which the metal stamper 3 is placed and at a distance D1 from the center axis C of the cut punch receiving portion 5 which is within the range of 4.0 to 6.0 mm. The fixed-side template 1 further has an air-blow hole 8 in an area between the periphery of the center hole of the metal stamper 3 and the cut punch receiving portion 5 and at distance D2 from the center of the cut punch receiving portion which is within the range of 2.0 to 4.7 mm. Air is blown against the injection-molded resin stamper through the air-blow hole 8.

The moving-side template 2 includes the cut punch 4 in the central portion. The end 9 of the cavity is tapered at an angle of 5 to 15° so as to widen the cavity from the moving-side template to the fixed-side template in a direction parallel to the center axis C of the cut punch receiving portion 5.

The metal stamper 3 has a center hole with a diameter R2 of 6.8 to 10.8 mm and a disc diameter R3 of at least 69.0 mm.

The die according to the present invention is applicable to a magnetic recording medium of at least 1.8 inches to 2.5 inches. Moreover, apparatuses, facilities, and the like for optical discs (a plating apparatus, an Ni stamper punching apparatus, and a back surface polishing apparatus) can desirably be used for the magnetic recording medium. Thus, the disc diameter R3 of the metal stamper 3 may be at most about 138 mm, which is a common value for Ni stampers for optical discs.

An air-blow hole 11 may optionally be formed in the moving-side template 2.

Another vacuum suction hole 10 may be formed in the fixed-side template 1.

In FIG. 3, the vacuum suction hole 7, the air-blow hole 8, and the air-blow hole 11 are composed of grooves each shaped like a circular arc that is concentric with the center axis C. The vacuum suction holes 7 and 10 are connected to a vacuum pump (not shown in the drawings). The air-blow holes 8 and 11 are connected to an air-blow apparatus (not shown in the drawings).

The die 30 described above can be used to mold a resin stamper as described below.

First, vacuuming is performed through the vacuum suction hole 7 to allow the surface of the metal stamper 3 located opposite the recess and protrusion shape to stick to the fixed-side template 1.

Then, an injection molding resin material is injected through the injection hole 6 and pressurized and cooled to obtain a molded component of the resin stamper.

Subsequently, the cut punch 4 is used to punch the molded component of the resin stamper to form a resin stamper.

Air is blown against the resin stamper through the air-blow hole 8 attached to the fixed-side template 1 to separate the fixed-side template 1 and the resin stamper from each other.

The moving-side template 2 and the resin stamper accommodated in the moving-side template 2 are removed from the fixed-side template 1.

The resin stamper is removed from the moving-side template 2 by suctioning a portion of the resin stamper outside the range of 65 mm from the center.

Burrs may be produced when the resin stamper is formed using the injection molding resin in FIG. 3. On a side of the injection molding die which is stuck to the ultraviolet-curable resin during the manufacture of a discrete track magnetic recording medium, a burr is likely to be formed by the cut punch at the air-blow hole for releasing of the molded component, the inner peripheral end of the metal stamper, the outer peripheral end of the molded component, or the inner peripheral end of the molded component.

To allow determination of how burrs are produced, a resin stamper of inner diameter 7 mm and outer diameter 75 mm was molded, and the protrusion heights of molding burrs produced at the above-described positions were measured.

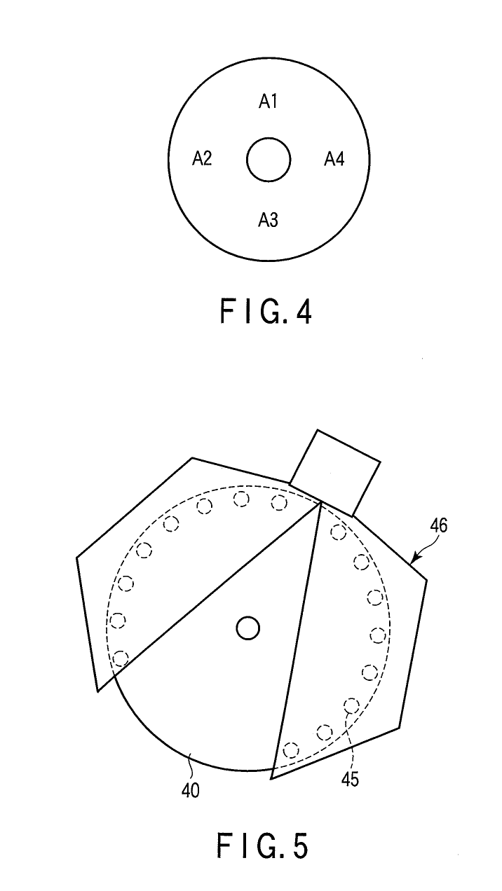

FIG. 4 shows measurement positions for molding burrs on the resin stamper.

A1 to A4 in FIG. 4 correspond to A1 to A4 in the table shown below.

Table 1 shows the results of the actual measurement of the heights of the protrusions.

TABLE 1

| Location | A1 | A2 | A3 | A4 |
|---|---|---|---|---|
| Stamper inner periphery (μm) | 9.5 | 14.3 | 3.8 | 10.8 |
| Air blow hole (μm) | 2.9 | 1.0 | 3.1 | 3.9 |
| Molded component outer | 0.0 | 20.9 | 0.0 | 1.3 |
| peripheral end (μm) | | | | |
| Inner peripheral cut punch (μm) | 0.0 | 0.0 | 0.0 | 0.0 |

The results show that values other that those for cut punch burrs are of the order of several μm, thus preventing the sticking from being achieved with a void of the order of several tens of nanometers. However, cut punch burrs of the order of several tens of nanometers may be present. The measurement results also indicate that the vacuum suction hole for attachment of the metal stamper included a step of about 40 μm and thus abutted against the back surface of the stamper, thus avoiding producing a protrusion on the molded component. Thus, the improper attachment of the metal stamper results in distortion of a pattern transferred to the molded component. Consequently, the radial position of the metal stamper may be properly determined.

Thus, the positions of possible burrs, that is, the positions of components including the air-blow hole, the inner peripheral end of the metal stamper, the outer peripheral end of the molded component, and the cut punch are defined so as to avoid interfering with the magnetic recording medium to be stuck to the stamper. However, the positions where these mechanisms are mutually arranged are limited. Furthermore, in view of productivity, the same injection molding die can desirably deal with magnetic recording media of both 1.8 inches and 2.5 inches, which are the common sizes of hard disc media. In view of these, the location of the resin stamper molding die according to the present invention is determined.

The size of the resin stamper according to the present invention may be such that the diameter of the center hole in the resin stamper, that is, the inner diameter of the resin stamper may be at most 8.0 mm, further 4 to 7 mm, and the diameter of the resin stamper, that is, the outer diameter of the resin stamper may be at least 69.0 mm, further may be 75 to 120 mm. That is, the size of the resin stamper may be such that the inner diameter of the stamper is smaller than that of a 1.8-inch magnetic recording medium to be stuck to the resin stamper and such that the outer diameter of the stamper is larger than that of a 2.5-inch magnetic recording medium to be stuck to the resin stamper. A sufficiently large diameter may be provided in order to allow a handling area to be formed on the outer peripheral side so that the molded component can be removed via the handling area.

The size of the metal stamper used in the present invention may be such that the metal stamper has an inner diameter of 6.8 to 10.8 mm and an outer diameter of at least 69.0 mm, further may be 100 to 138 mm. The size is desirably such that the metal stamper has an inner diameter smaller than that of the 1.8-inch magnetic recording medium and larger than the outer diameter of the 2.5-inch magnetic recording medium, and has a larger outer diameter than the molded component if possible.

The vacuum suction hole allowing the metal stamper to be attached is located in the area in which the metal stamper is placed and within the range of 4.0 to 6.0 mm from the center of the cut punch receiving portion. The area is located outside the inner periphery of the metal stamper and is smaller than the outer periphery of the magnetic recording medium.

The position of the air-blow hole for releasing of the molded component is at a distance of 2.0 to 4.7 mm from the center of the cut punch receiving portion. Forming the air-blow hole at this position allows air to be blown against the vicinity of the center hole of the molded component regardless of the inner peripheral portion of the metal stamper.

The size specifications used for the present invention have been described. For automated mass production of resin stampers, these size specifications allow the resin stamper, which is a molded component, to be removed from the die using a work robot.

FIG. 5 is a schematic diagram showing an example of a work robot that can be used in the method according to the present invention.

As shown in FIG. 5, a suction space in which a plurality of suction pads 45 allowing a robot 46 to handle the molded resin stamper 40 may be provided in a place other than a recording area.

Cycloolefin polymer, which is likely to be used as a molding material, is subject to only insignificant molding contraction and thus tends to prevent the resin stamper from being smoothly removed from the die. However, the resin stamper can be more easily removed from the die by suctioning a portion of the resin stamper outside the range of 32.5 mm from the center of the stamper. That is, the molded component may include a handling area extending 32.5 to 34.5 mm from the center.

The periphery of the cavity portion of the moving-side template is tapered so as to widen from the moving-side template toward the fixed-side template. The taper angle is set to an angle of 5 to 15° to a direction parallel to the cut punch on the moving-side template or the center axis of the cut punch receiving portion of the fixed-side template. Then, even with an injection molding resin material that is subject to only insignificant molding contraction, the resin stamper can be removed from the die.

The following will be described below in detail: the position where the vacuum suction hole in the stamper molding die for use in the present invention is formed, the position where the air-blow hole is formed, the taper angle of the moving-side template, and the sizes of the Ni stamper and the resin stamper.

First, the outer peripheral side will be described.

Lower limit of the outer diameter of the resin stamper

First, to examine the lower limit of the outer diameter of the resin stamper, experiments were made with the size of the resin stamper varied.

The 2.5-inch medium has an outer periphery of about 65 mm, and a handling area can be provided in a portion of the resin stamper outside the outer periphery. However, each of the vacuum suction pads of the robot handling the molded component has a diameter of at least 2 mm. Pads each with a diameter of 1.9 mm actually failed to allow the molded component to be handled because of an insufficient suction force. Thus, the handling area for the molded component may have an outer diameter of 69 mm, that is, a diameter of 65+(2×2) mm. This handling area successfully allowed the resin stamper to be stably removed. A resin stamper of outer diameter at least 120 mm disadvantageously prevented the same apparatuses, facilities, and the like for optical discs such as a conveying apparatus from being used for magnetic recording media.

Lower limit of the outer diameter of the Ni stamper

Then, to examine the lower limit of the outer diameter of the Ni stamper, experiments were made with the size of the Ni stamper varied.

When the outer diameter of the Ni stamper was set to be smaller than that of the resin stamper, for example, 68.9 or 64.9 mm, a step produced on the Ni stamper caused a step to be produced on the resin stamper. This affected the handling and sticking. Thus, the outer diameter of the Ni stamper is desirably larger than that of the resin stamper, that is, at least 69 mm. An Ni stamper of outer diameter 69 mm successfully enabled stable handling and sticking. An Ni stamper of outer diameter at least 138 mm disadvantageously prevented the same apparatuses, facilities, and the like for optical discs such as an Ni stamper punching apparatus from being used for magnetic recording media.

Maximum value for the area in which the vacuum suction hole is formed

Then, to determine the maximum value for the area in which the vacuum suction hole through which the Ni stamper is suctioned is formed, experiments were made with the position of the Ni stamper suction hole varied.

When the area was located at a distance of 6.05 mm from the center of the cut punch receiving portion and was larger than the inner diameter of the 1.8-inch medium, that is, 12 mm, a resulting burr on the molded component prevented the sticking. When the area was located at a distance of 6.0 mm from the center of the cut punch receiving portion, the sticking was successfully achieved evenly.

Maximum value of the inner diameter of the Ni stamper

Then, to determine the maximum value of the inner diameter of the Ni stamper, experiments were made with the inner diameter of the Ni stamper varied.

When each of the above-described vacuum suction holes had a diameter of 0.5 mm, the suction force was insufficient, preventing the Ni stamper from being suctioned or causing the Ni stamper to come off during molding. Vacuum suction holes each of diameter 0.6 mm successfully allowed the Ni stamper to be stably suctioned. Thus, the maximum value of the inner diameter of the Ni stamper needed to be at least 10.8 mm, that is, (the maximum diameter of the stamper suction hole: 12.0 mm)−(the diameter of the vacuum suction hole: 0.6 mm×2). An Ni stamper with this inner diameter successfully enabled stable molding. An Ni stamper of inner diameter smaller than 5.4 mm disadvantageously prevented the resin injection port, the cut punch (receiving) mechanism, and the air-blow mechanism from being provided with sufficient spaces.

Then, to determine the maximum value for the area in which the mold-releasing air-blow hole is formed, experiments were made with the area in which the mold releasing air-blow hole was formed.

First, a guide for the Si stamper can be provided in the diameter portion of the center hole in the Ni stamper. When this guide portion is brittle, the Ni stamper is misaligned to decenter the resin stamper or the finished magnetic recording medium. When the thickness of the guide portion was actually set to 0.6 mm, the resin stamper was decentered by at least 100 μm, which is an impermissible value. When the thickness of the guide portion was set to 0.7 mm, the decentering amount of the resin stamper decreased to at most 30 μm, which is a permissible value. If the thickness of the guide portion is 0.7 mm when the inner diameter of the Ni stamper exhibits the maximum value of 10.8 mm, the maximum value of the diameter of the mold-releasing air-blow hole area, provided inside the guide portion, is 10.8−(0.7×2)=9.4 mm. That is, when the mold-releasing air-blow hole area was located at a distance of 4.7 mm from the center of the cut punch receiving portion, the molding of the resin stamper with the decentering amount reduced was successfully achieved.

In connection with the inner diameter of the resin stamper, when the above-described mold-releasing air-blow hole had a diameter of 0.6 mm, the resin stamper, a molded component, failed to be released from the die because of the insufficient flow rate of air. A resin stamper of inner diameter 0.7 mm successfully enabled stable mold releasing. Thus, to allow mold-releasing air to be blown against the resin stamper, the inner diameter of the resin stamper can be set to at most 8 mm=(the maximum value of the mold-releasing air-blow hole area: 9.4 mm)−(0.7 mm×2). A resin stamper of inner diameter at most 8 mm was successfully released from the die.

The minimum value of the mold-releasing air-blow hole area, the minimum value of the inner diameter of the Ni stamper, and the minimum value for the Ni stamper suction hole area are as follows.

First, to define the minimum value for the mold-releasing air-blow hole area, the size of the resin injection hole is defined. To obtain a sufficient flow rate during filling of the resin, the diameter of the resin injection hole need to be at least 2.6 mm. An injection hole of diameter up to 2.5 mm actually required an excessively long time and excessively high stress for the resin filling. This prevented the capability of achieving even transfer and uniform mechanical properties from being obtained. An injection molding resin material can be used which exhibits a molten viscosity of, for example, 60 g/10 min to 80 g/10 min at 230° C. When the resin injection hole has a diameter of 2.6 mm, the diameter of the cut punch mechanism, which cuts the inner diameter of the resin stamper, can be set to 4 mm. That is, a cut blade of size at least (4−2.6)/2=0.7 mm can be used. A cut blade of size less than or equal to 0.7 mm, for example, a cut blade of size 0.6 mm, cannot sufficiently punch the center hole in the resin stamper. The insufficient punching led to a half cut. The mold releasing air-blow hole area can be provided outside the cut punch in order to blow air directly against the resin stamper. The diameter of the mold-releasing air-blow hole thus has a minimum value of 4 mm. This diameter successfully enabled the resin stamper to be released from the die.

Now, the minimum value of the inner diameter of the Ni stamper will be discussed. To allow mold-releasing air to be blown directly against the resin stamper, it is obviously necessary that (the inner diameter of the Ni stamper)>(the mold-releasing air-blow hole area+the diameter of the mold−releasing blow hole)+(the above-described guide portion for the inner diameter of the Ni stamper). As described above, the experiment results show that the minimum value for the mold-releasing air-blow hole area is 4 mm, the diameter of the air-blow hole required for mold releasing is at least 0.7 mm, and the thickness of the inner guide portion is at least 0.7 mm. Thus, the inner diameter of the Ni stamper cannot take a value less than or equal to 6.8 mm, i.e., (4+0.7×2)+(0.7×2) mm. Consequently, this is the minimum value of the inner diameter of the Ni stamper.

For the minimum value for the Ni stamper suction hole area, the experiment results show that the inner diameter of the Ni stamper is at least 6.8 mm, a suction force exerted at a suction hole diameter of 0.5 mm is insufficient to stably suction the Ni stamper, and a suction hole diameter of at least 0.6 mm is required for the stable suction, as described above. That is, the minimum value for the Ni stamper suction hole area may be set to 6.8+0.6×2=8.0 mm. This minimum value actually allowed stable molding to be achieved with the Ni stamper prevented from coming off.

The taper will be described below which is provided on the periphery of the cavity portion of the moving-side template so as to widen from the moving-side template toward the fixed-side template. When the taper angle was set to 4°, the molded component failed to be stably removed from the die. Thus, consecutive molding was difficult. A taper angle of 5° successfully enabled the molded component to be stably removed from the die. A taper angle of 15° allowed the molded component to be removed from the die without a problem. However, a taper angle of 16° was excessively large, so that the molded component fell down from the die under the weight of the molded component before the robot removed the molded component from the die. The fallen molded component became defective and unusable. This indicates that a taper angle of at least 16° prevents the desired molded component from being obtained. Thus, the taper angle may be set to 5 to 15°.

The die according to the present invention was used form a discrete track magnetic recording medium.

Dimensions of the Die

Fixed-Side Template

Resin injection hole, diameter: 2.6 mm

Cut punch receiving portion, diameter: 7 mm

Vacuum suction hole: circular groove at a distance of 5 mm from the center of the cut punch receiving portion

Air-blow hole: circular groove at a distance of 4.5 mm from the center of the cut punch receiving portion

Moving-Side Template

Cut punch diameter: 7 mm

Taper of the peripheral portion of the cavity: 13°

A die with the above-described dimensions was used and cycloolefin polymer was applied as an injection molding resin material to manufacture a resin stamper of inner diameter 7 mm and outer diameter 75 mm.

The resin stamper was used to manufacture a 1.8-inch magnetic recording medium with discrete tracks. For the resulting magnetic recording medium with the discrete tracks, the thickness of the resist and transfer were measured using a polarized light observation apparatus.

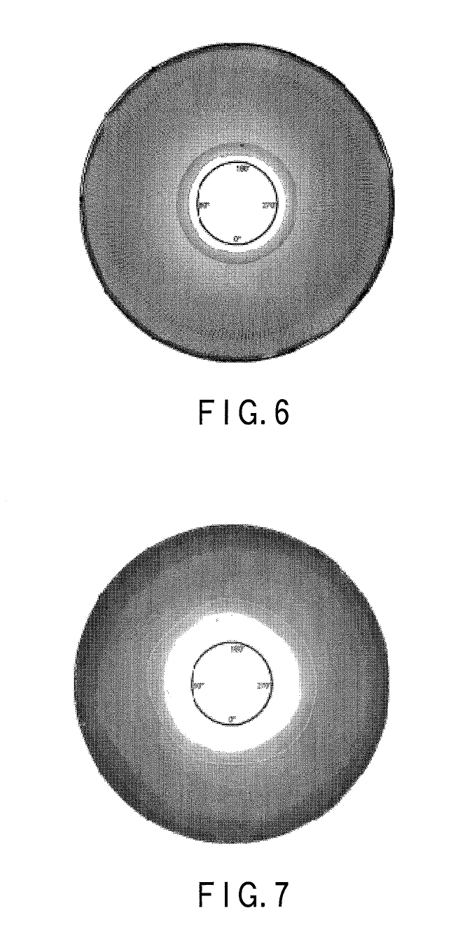

The results are shown in FIG. 6.

For comparison, a resin stamper with an inner diameter equal to that of the magnetic recording medium, that is, 12 mm, was formed using a die deviating from the scope of the present invention. The resin stamper was used to manufacture a magnetic recording medium with discrete tracks. For the resulting magnetic recording medium with the discrete tracks, the thickness of the resist and transfer were similarly measured based on polarized light observation.

The results are shown in FIG. 7.

With the stamper size of the die and the positions of the stamper suction hole and the mold-releasing air-blow hole set according to the present invention, the molded resin stamper can be stuck to both 1.8- and 2.5-inch magnetic recording media with burrs on the stamper prevented from interfering with the sticking. FIG. 7 shows that a 1.8-inch magnetic recording medium has been stuck to a molded resin stamper with the same size as that of the magnetic recording medium. FIG. 7 shows that burrs produced at the end of the center hole in the resin stamper interfere with the sticking to float the inner peripheral portion of the magnetic recording medium. On the other hand, FIG. 6 shows that a 1.8-inch magnetic recording medium has also been stuck to a resin stamper dimensioned according to the present invention and molded using a die configured according to the present invention. FIG. 6 shows that the magnetic recording medium has been correctly patterned without floating on both the inner and outer peripheral sides.

Furthermore, for improved productivity, the automated removal of a molded component from a die using a robot is effective on products such as hard discs which are mass-produced on a clean manufacture line. Defining the size of the resin stamper according to the present invention enables handling to be achieved using the robot based on vacuum suction. Furthermore, when a molding material such as cycloolefin, polycarbonate, or acrylic is used which is subject to only insignificant molding contraction in order to allow a fine pattern to be accurately transferred, the die structure with the taper according to the present invention enables smooth removal from the die.

Another effect of the present invention is such that the magnetic recording medium can be prevented from being contaminated with cut punch chips by locating the cut punch portion for the diameter of the center hole, which is the greatest source of dust during resin injection molding, away from the magnetic recording medium, that is, setting the diameter of the cut punch portion for the diameter of the center hole in the resin stamper to at most 8.0 mm with respect to the diameter of the center hole in the magnetic recording medium, 12.01 mm.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A resin stamper molding die comprising a combination of a fixed side template, a metal stamper on the fixed side template comprising a recess and a protrusion-shaped surface, and a movable side template opposite to the fixed plate with regards to the metal stamper, the die being used for injection-molding a disc-shaped resin stamper with a center hole,
wherein the fixed side template comprises, in a central portion, a cut punch receiver configured to receive a cut punch configured to punch a center hole in the resin stamper and an injection hole connected to the cut punch receiver configured to allow an injection molding resin material to be injected, and the fixed side template comprises a vacuum contact hole in an area comprising the metal stamper and within a range of 4.0 to 6.0 mm from a center of the cut punch receiver, the metal stamper being in contact with the vacuum contact hole, and an air-blow hole in an area between the cut punch receiver and the area comprising the metal stamper and within a range of 2.0 to 4.7 mm from the center of the cut punch receiver, the air-blow hole is configured to lead air flow against the injection-molded resin stamper through the air-blow hole,
the movable side template comprises the cut punch in a central portion and a taper on a peripheral portion of a cavity in the movable side template and slanted at an angle of 5° to 15° to a direction parallel to a center axis of the cut punch, and
the metal stamper comprises an outer diameter of at least 69.0 mm and a center hole comprising a diameter of approximately 6.8 to 10.8 mm.

2. The die of claim 1, wherein the cut punch receiver comprises a diameter of 2.6 to 4.0 mm.

3. The die of claim 1, wherein the periphery of the cavity in the movable side template comprises a circular contour comprising a diameter larger than 69 mm.

4. The die of claim 1, wherein the movable side template further comprises an air-blow hole configured to lead air flow against the injection-molded resin stamper.

5. A method for molding a disc-like resin stamper comprising a center hole configured to be applied in transferring a recess and protrusion pattern comprising discrete tracks to an ultraviolet-curable resin used as a mask in such a manner that the discrete tracks are formed in a surface of a magnetic recording layer,
wherein the resin stamper is injection-molded using a die comprising a combination of a fixed side template, a metal stamper on the fixed-side template and comprising a recess and protrusion-shaped surface, and a movable side template opposite to the fixed-side template with regards to the metal stamper, the die being used to injection-mold a disc-shaped resin stamper with a center hole,
the fixed side template comprises, in a central portion, a cut punch receiver configured to receive a cut punch configured to punch a center hole in the resin stamper and an injection hole connected to the cut punch receiver configured to allow an injection molding resin material to be injected, and the fixed side template comprises a vacuum contact hole in an area comprising the metal stamper and within a range of 4.0 to 6.0 mm from a center of the cut punch receiver, the metal stamper being in contact with the vacuum contact hole, and an air-blow hole in an area between the cut punch receiver and the area comprising the metal stamper and within a range of 2.0 to 4.7 mm from the center of the cut punch receiver, the air-blow hole is configured to lead air flow against the injection-molded resin stamper through the air-blow hole,
the movable side template comprises the cut punch in a central portion, a center hole comprising a diameter equal to or less than 8.0 mm, and a cavity comprising an outer diameter of at least 69 mm and corresponding to a resin stamper, and the movable side template comprises a taper in a peripheral portion of the cavity and slanted at an angle of 5° to 15° to a direction parallel to a center axis of the cut punch,
the metal stamper comprises an outer diameter of at least 69.0 mm and a center hole with a diameter of 6.8 to 10.8 mm, and
the method comprises:
vacuuming through the vacuum contact hole to attach a surface of the metal stamper opposite to the recess and protrusion shape to the fixed side template;
injecting an injection molding resin material through the injection hole and then pressurizing and cooling the material in order to obtain a molded component of the resin stamper;
punching the molded component of the resin stamper in order to form the resin stamper;
flowing air against the molded component through the air-blow hole attached to the fixed side template in order to separate and remove the resin stamper from the fixed side template; and
removing the resin stamper from the movable-side template.

6. The method of claim 5, wherein an outer diameter of the cut punch and an inner diameter of the cut punch receiver are 2.6 to 4.0 mm.

7. The method of claim 5, wherein the periphery of the cavity in the movable side template comprises a circular contour comprising a diameter larger than 69 mm.

8. The method of claim 5, wherein the movable side template further comprises an air-blow hole configured to lead air flow against the injection-molded resin stamper, and the air is configured to flow against the stamper through the air-blow hole while removing the resin stamper from the fixed side template.

9. The method of claim 5, further comprising attaching a portion of the resin stamper outside a range of 32.5 mm from a center of the resin stamper to the vacuum contact hole, in removing the resin stamper from the movable side template.
